(19) United States
(12) Patent Application Publication
(10) Pub. No.: US 2019/0150432 A1
(43) Pub. Date: May 23, 2019

(54) COMPOSITIONS OF MATTER INCLUDING TRIAZINE-BASED HERBICIDES

(71) Applicant: International Business Machines Corporation, Armonk, NY (US)

(72) Inventors: BRANDON M. KOBILKA, TUCSON, AZ (US); JOSEPH KUCZYNSKI, NORTH PORT, FL (US); JACOB T. PORTER, HIGHLAND, NY (US); JASON T. WERTZ, PLEASANT VALLEY, NY (US)

(21) Appl. No.: 15/820,422

(22) Filed: Nov. 21, 2017

(51) Int. Cl. A01N 25/12; A01N 43/707; A01N 43/68; C05C 9/00

(52) U.S. Cl. CPC A01N 25/12; C05C 9/00; A01N 43/68; A01N 43/707

(57) ABSTRACT

A composition of matter includes a hydroxyapatite particle and a triazine-based herbicide. In some cases, the triazine-based herbicide is adsorbed to a surface of the hydroxyapatite particle. In other cases, the triazine-based herbicide is chemically bound to the surface of the hydroxyapatite particle via a urea linkage.

### BACKGROUND

Urea is a rich source of nitrogen and is the most commonly used nitrogen fertilizer. A shortcoming of the use of urea as a fertilizer is premature decomposition into ammonia before it can be efficiently adsorbed by the plants. Further, control of undesirable plants such as broad leaf weeds is also of concern as these species tend to compete with the crop for the fertilizer, thereby increasing fertilizer demand. Herbicides are commonly utilized to control such broad leaf weeds. Both fertilizers and herbicides represent significant costs to agriculture and may present challenges to improved food production efficiency to satisfy a growing population. Accordingly, there is a need to reduce costs associated with both fertilizers and herbicides.

### SUMMARY

According to an embodiment, a composition of matter includes a hydroxyapatite particle and a triazine-based herbicide adsorbed to a surface of the hydroxyapatite particle.

According to another embodiment, a composition of matter includes a hydroxyapatite particle and a triazine-based herbicide chemically bound to a surface of the hydroxyapatite particle via a urea linkage.

According to yet another embodiment, a process includes forming a solution that includes an isocyanate-functionalized hydroxyapatite particle and a triazine-based herbicide. The isocyanate-functionalized hydroxyapatite particle includes an isocyanate functional group that is linked to a surface of the hydroxyapatite particle. The process also includes initiating a chemical reaction to chemically bind the triazine-based herbicide to the surface of the hydroxyapatite particle via a urea linkage. The urea linkage results from a chemical reaction of an amine group of the triazine-based herbicide and the isocyanate functional group of the isocyanate-functionalized hydroxyapatite particle.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates a composition of matter that includes a hydroxyapatite (HA) particle and a triazine-based herbicide adsorbed to a surface of the HA particle, according to one embodiment.

FIGS. 2A and 2B illustrate a process of chemically binding a first example of a triazine-based herbicide to a surface of an isocyanate-functionalized HA particle via a hydrolysable urea linkage to enable controlled release of the triazine-based herbicide, according to one embodiment.

FIG. 3 illustrates a process of forming the isocyanate-functionalized HA particle depicted in FIG. 2A, according to one embodiment.

FIGS. 4A and 4B illustrate a process of chemically binding a second example of a triazine-based herbicide to a surface of an isocyanate-functionalized HA particle via a hydrolysable urea linkage to enable controlled release of the triazine-based herbicide, according to one embodiment.

FIGS. 5A and 5B illustrate a process of chemically binding a third example of a triazine-based herbicide to a surface of an isocyanate-functionalized HA particle via a hydrolysable urea linkage to enable controlled release of the triazine-based herbicide, according to one embodiment.

FIGS. 6A and 6B illustrate a process of chemically binding a fourth example of a triazine-based herbicide to a surface of an isocyanate-functionalized HA particle via a hydrolysable urea linkage to enable controlled release of the triazine-based herbicide, according to one embodiment.

FIGS. 7A and 7B illustrate a process of chemically binding a fifth example of a triazine-based herbicide to a surface of an isocyanate-functionalized HA particle via a hydrolysable urea linkage to enable controlled release of the triazine-based herbicide, according to one embodiment.

FIGS. 8A and 8B illustrate a process of chemically binding a sixth example of a triazine-based herbicide to a surface of an isocyanate-functionalized HA particle via a hydrolysable urea linkage to enable controlled release of the triazine-based herbicide, according to one embodiment.

FIGS. 9A and 9B illustrate a process of chemically binding a seventh example of a triazine-based herbicide to a surface of an isocyanate-functionalized HA particle via a hydrolysable urea linkage to enable controlled release of the triazine-based herbicide, according to one embodiment.

FIGS. 10A and 10B illustrate a process of chemically binding an eighth example of a triazine-based herbicide to a surface of an isocyanate-functionalized HA particle via a hydrolysable urea linkage to enable controlled release of the triazine-based herbicide, according to one embodiment.

FIGS. 11A and 11B illustrate a process of chemically binding a ninth example of a triazine-based herbicide to a surface of an isocyanate-functionalized HA particle via a hydrolysable urea linkage to enable controlled release of the triazine-based herbicide, according to one embodiment.

FIG. 12 is a flow diagram illustrating an example of a process of forming a composition of matter that includes a hydroxyapatite particle and a triazine-based herbicide adsorbed to a surface of the hydroxyapatite particle, according to one embodiment.

FIG. 13 is a flow diagram illustrating an example of a process of forming a composition of matter that includes a hydroxyapatite particle and a triazine-based herbicide chemically bound to a surface of the hydroxyapatite particle via a urea linkage, according to one embodiment.

### DETAILED DESCRIPTION

The present disclosure describes compositions of matter that enable the slow release of an herbicide/fertilizer through biodegradability on a particle (e.g., a nanoparticle or a microparticle). In some embodiments of the present disclosure, the surface of a hydroxyapatite (HA) particle is modified such that a biodegradable herbicide and an optional fertilizer are adsorbed to the surface of the HA particle. For example, in some cases, an herbicide (e.g., a triazine-based preemergent herbicide) may be adsorbed to the surface of the HA particle. In other cases, both urea and the herbicide may be adsorbed to the surface of the HA particle. The biodegradable nature of the linkage associated with the herbicide/fertilizer may enable slow release of the herbicide/fertilizer.

In other embodiments of the present disclosure, the herbicide may be chemically bound to the surface of an HA particle. For example, the surface hydroxyl groups of the HA particle may be modified to link an isocyanate functional group to the surface of the HA particle. The isocyanate functional group may react with an amine group of a triazine-based herbicide to form a urea linkage. The urea linkage is a hydrolysable group that reverts the original amine structure to its starting form, leaving an amine-functionalized HA particle. The hydrolysis reaction leaves the original triazine-based herbicide free to act upon undesirable plants and weeds.

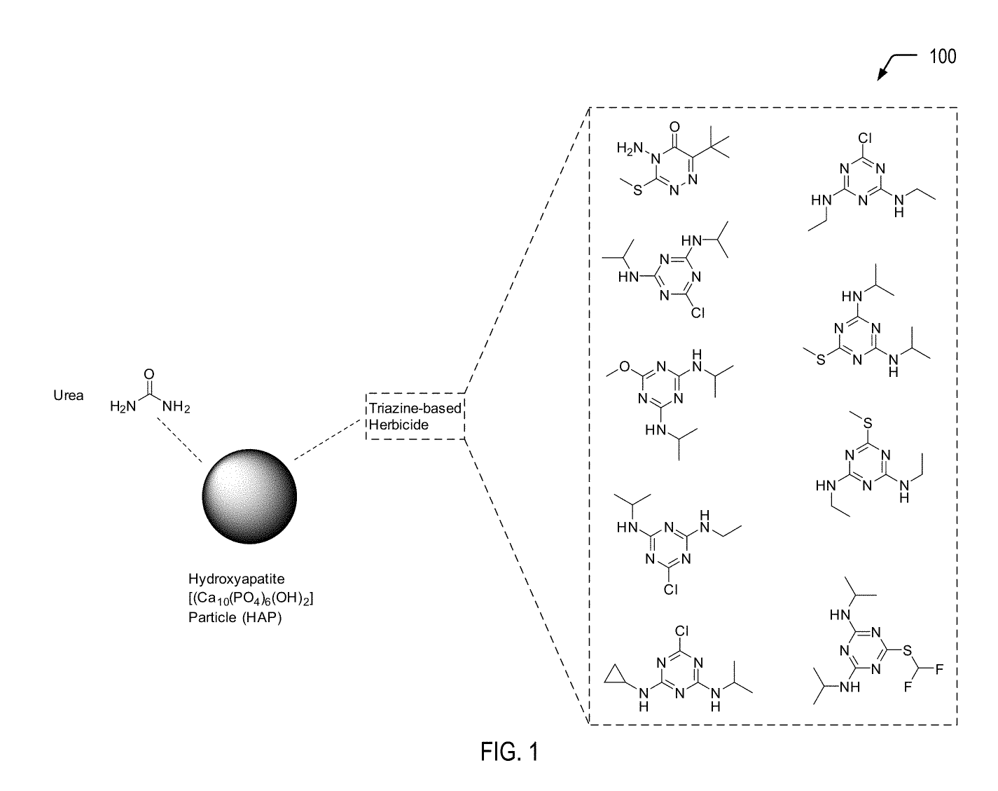

Referring to FIG. 1, a diagram 100 illustrates a composition of matter that includes an HA particle and a triazine-based herbicide adsorbed to a surface of the HA particle, according to one embodiment. In the particular embodiment depicted in FIG. 1, a fertilizer (urea) is also adsorbed to the surface of the HA particle. Adsorption of the herbicide to the HA particle enables controlled release of the triazine-based herbicide to act upon undesirable plants and weeds. Adsorption of urea to the HA particle enables controlled release of fertilizer to address the challenges associated with the premature decomposition of urea in soil.

Hydroxyapatite [Ca₁₀(PO₄)(OH)₂] particles are biocompatible and a rich phosphorus source. Further, the high surface area of the hydroxyapatite nanoparticles enables binding of a high ratio of herbicide and fertilizer to the particles. The right side of FIG. 1 illustrates various examples of triazine-based herbicides that may be adsorbed to the surface of the HA particle. It will be appreciated that alternative triazine-based herbicides may also be utilized. Further, more than one of the triazine-based herbicides may be adsorbed to the surface of the HA particle.

As one example, the hybrid HA particle depicted in FIG. 1 may be synthesized by stirring a solution that includes HA nanoparticles (e.g., commercially available <200 nm HA particles from Sigma-Aldrich), urea, and a triazine-based herbicide to adsorb the urea/herbicide to the surface of the HA nanoparticles. The resulting solution may be dried to yield herbicide-fertilizer HA hybrid nanoparticles. As another example, the hybrid HA particle depicted in FIG. 1 may be formed according to the following prophetic procedure. A triazine-based herbicide and urea (10 equiv.) may be dissolved in a suspension of calcium hydroxide (1 equiv., 1.75 M) and allowed to mix for 45 minutes. Phosphoric acid (0.6 M, 2.5 mol %) may be added dropwise to the suspension. The resulting composite may be allowed to stir under mechanical agitation for a further 2 hours. The resulting HA nanoparticle dispersion may be dried using a flash drying technique to yield an herbicide-fertilizer HA hybrid nanoparticle.

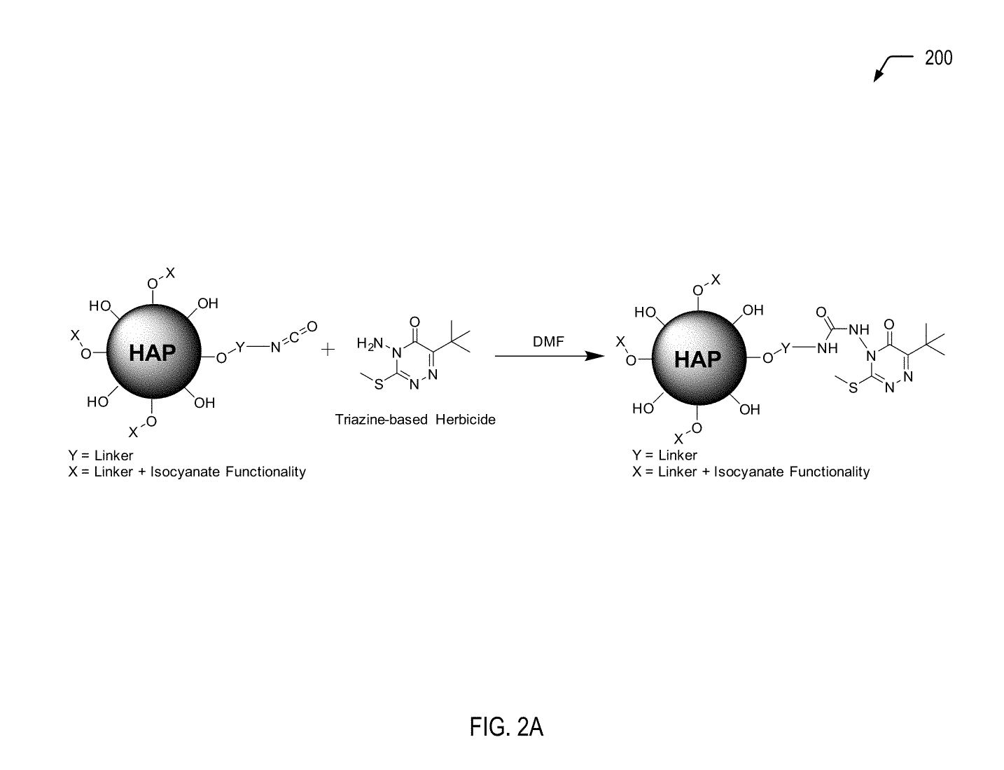

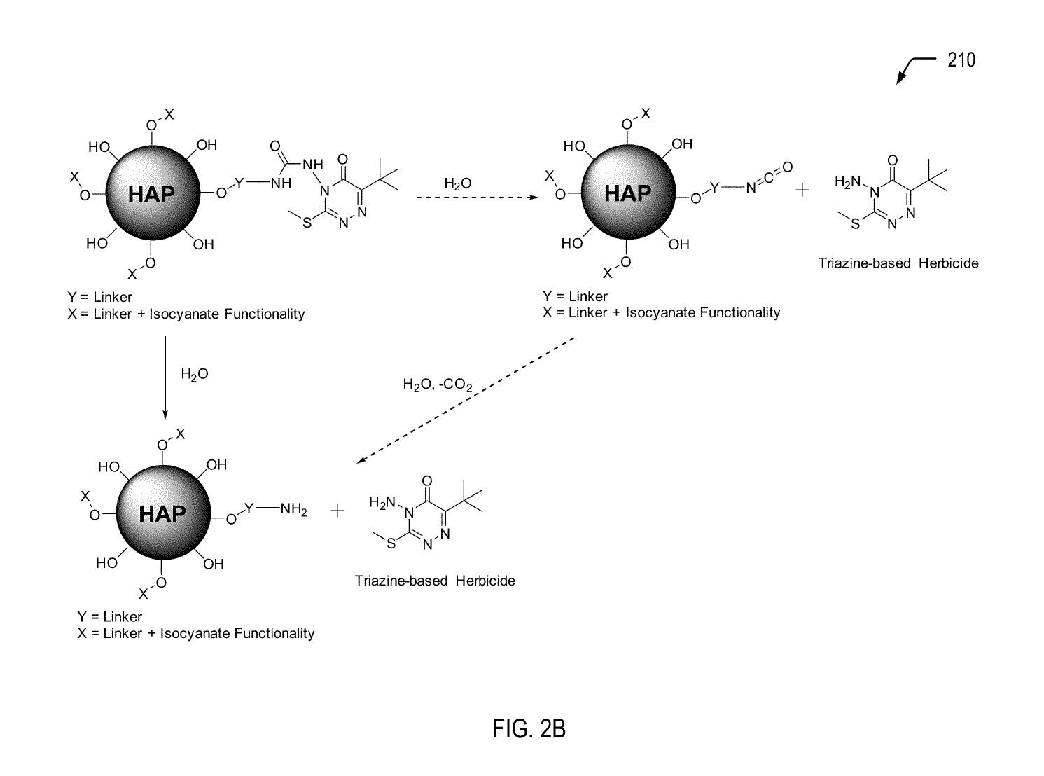

FIGS. 2A and 2B illustrate a process of chemically binding a first example of a triazine-based herbicide to a surface of an isocyanate-functionalized HA particle via a hydrolysable urea linkage to enable controlled release of the triazine-based herbicide, according to one embodiment.

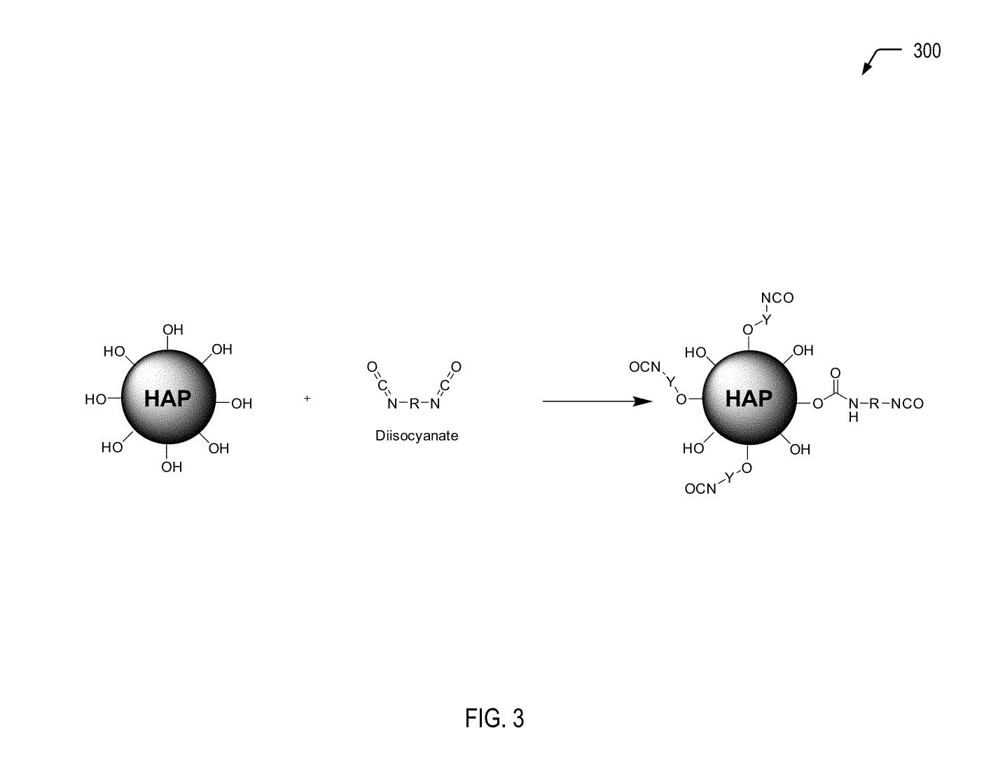

Referring to FIG. 2A, a chemical reaction diagram 200 illustrates an example of a process of chemically binding a triazine-based herbicide to a surface of an HA particle via a urea linkage. The left side of the chemical reaction diagram 200 illustrates an isocyanate-functionalized HA particle, with Y representing a linking group to an isocyanate functional group and X representing both the linking group and the isocyanate functional group. As illustrated and further described herein with respect to FIG. 3, the isocyanate-linker combination may have been derived from a diisocyanate material, such as methylene diphenyl diisocyanate (MDI) or toluene diisocyanate (TDI), where one end of the isocyanate molecule has been reacted with surface hydroxyls of an HA particle to form a urethane moiety.

The left side of the chemical reaction diagram 200 further illustrates an example of a triazine-based herbicide that includes a primary amine group having the following chemical structure:

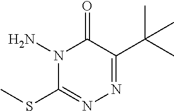

The process may include forming a solution that includes the isocyanate-functionalized hydroxyapatite particle and the first example triazine-based herbicide, then initiating a chemical reaction to bind the herbicide to the surface of the HA particle. For example, the isocyanate-functionalized hydroxyapatite particle and a molar excess of the triazine-based herbicide molecule depicted in FIG. 2A may be dissolved or suspended in dimethylformamide (DMF) at an approximate concentration of 1M with respect to the herbicide. The reaction mixture may be stirred vigorously overnight at room temperature or at a temperature up to 100° C. The particles may be collected by filtration or by precipitation into a non-solvent such as methanol, acetone, diethyl ether, or hexane. The particles may be rinsed with additional solvent, purified by centrifugation, and dried in a vacuum oven. The right side of the chemical reaction diagram 200 illustrates that the amine group of the triazine-based herbicide reacts with the isocyanate group to form a urea linkage.

Referring to FIG. 2B, a chemical reaction diagram 210 illustrates that the urea bonds are hydrolysable groups that revert the original amine structure back to its starting form, leaving an amine-functionalized HA particle. FIG. 2B illustrates that the hydrolysis reaction leaves the original triazine-based herbicide free to act upon undesirable plants and weeds. In FIG. 2B, the dashed arrows are designed to depict the intermediate reaction products. Specifically, proceeding from top to bottom, FIG. 2B illustrates that reacting the HA particle (top left) with water results in the bottom-left products (i.e., HAP with amine functionality and the triazine-based herbicide). Proceeding along the dashed reaction arrow from top left to right, FIG. 2B illustrates cleavage of the urea linkage to form the HAP with isocyanate functionality and release of the triazine-based herbicide. Proceeding along the dashed reaction arrow from top right to bottom left, FIG. 2B illustrates that subsequent reaction of the HAP-isocyanate with water evolves carbon dioxide.

Referring to FIG. 3, a chemical reaction diagram 300 illustrates an example of a process of forming the isocyanate-functionalized HA particle depicted on the left side of FIG. 2A.

The left side of the chemical reaction diagram 300 illustrates an HA particle (that includes surface hydroxyl groups) and a diisocyanate material (with R representing a linkage between the two isocyanate groups). As an example, the diisocyanate material may correspond to MDI or TDI, among other alternatives. The HA particles may correspond to commercially available hydroxyapatite particles, such as an HA nanopowder with particles with <200 nm particle sizes available from Sigma-Aldrich. The right side of the chemical reaction diagram 300 illustrates that one of the isocyanate groups of the diisocyanate material reacts with the surface hydroxyls of the HA particle to form a urethane moiety. The right side of the chemical reaction diagram 300 further illustrates that the other isocyanate group of the diisocyanate material remains available for subsequent chemical reaction with an amine group of one of the triazine-based herbicides described herein.

As a prophetic example, an excess of diisocyanate material may be added to a dilute suspension of hydroxyapatite nanoparticles in an anhydrous organic solvent such as DMF, dimethylsulfoxide (DMSO), dichloromethane, chloroform, etc. As one example, 10 g of dried HA nanoparticles (e.g., <200 nm particles from Sigma-Aldrich), 98 mL of DMF, and 2 mL of diisocyanate material (e.g., MDI or TDI) may be added to a 250 mL flask. In some cases, dibutyltin dilaurate (1 mL) may be used as a catalyst for the reaction. Optionally, hydroquinone may be used as an inhibitor. The resulting mixture may be maintained at a certain temperature (e.g., 50° C.) under N₂ protection. At certain time intervals, a 1.5 mL sample may be taken from the reaction vessel, and the powder may be separated by centrifugation. The powder may be washed first with DMF three times and then with CHCl₃ two times to remove the DMF. Samples may be dried at 60° C. to yield an isocyanate-functionalized HA particle.

Thus, FIG. 3 illustrates an example of a process of binding an isocyanate group to an HA particle. The isocyanate group enables one of the triazine-based herbicides described herein to be chemically bound to a surface of the HA particle, via a hydrolysable urea linkage. After application of the HA particles, hydrolysis of the urea linkage enables controlled release of the original triazine-based herbicide from the HA particle in order to act upon undesirable plants and weeds.

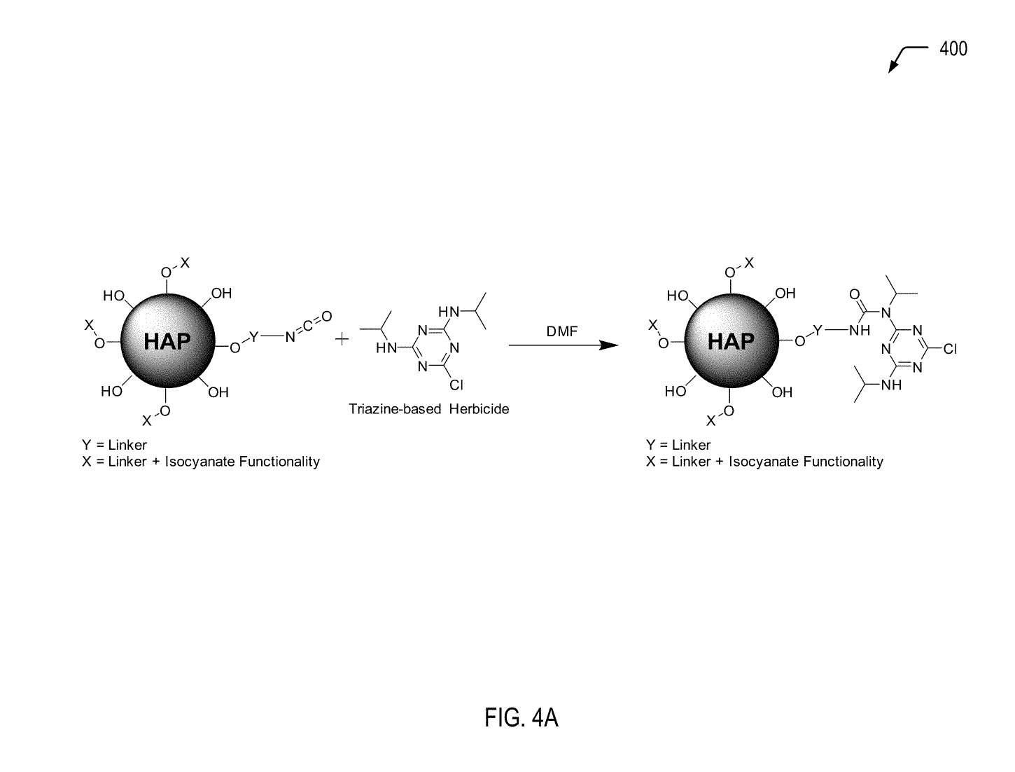

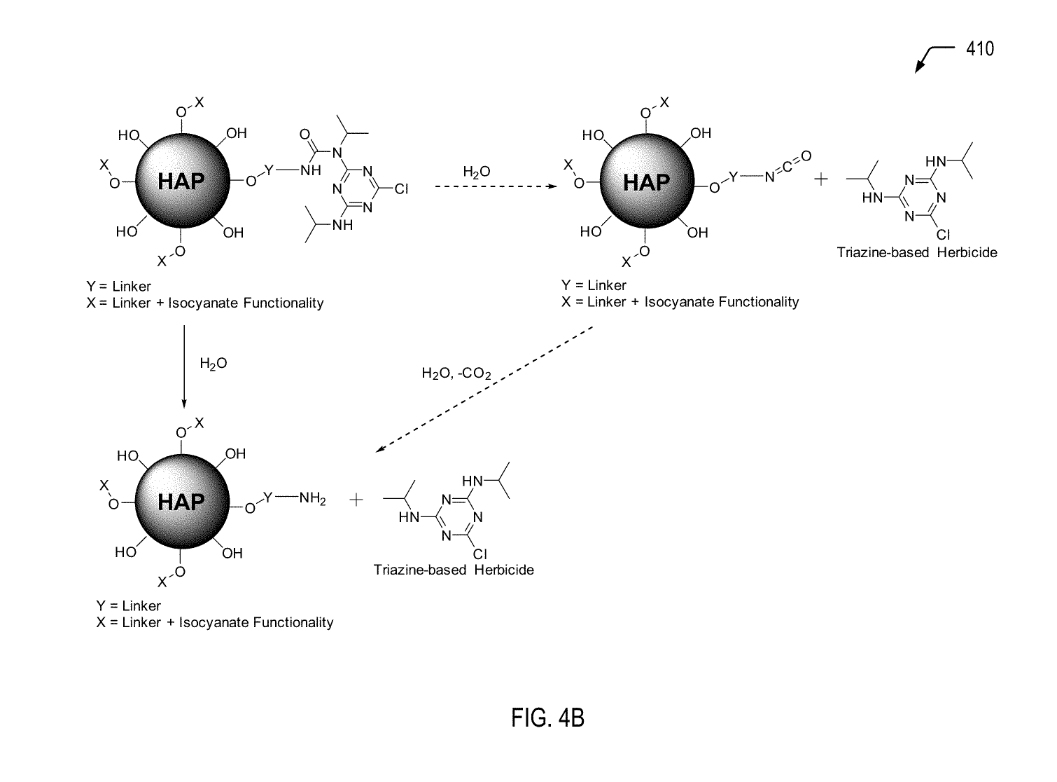

FIGS. 4A and 4B illustrate a process of chemically binding a second example of a triazine-based herbicide to a surface of an isocyanate-functionalized HA particle via a hydrolysable urea linkage to enable controlled release of the triazine-based herbicide, according to one embodiment.

Referring to FIG. 4A, a chemical reaction diagram 400 illustrates an example of a process of chemically binding a triazine-based herbicide to a surface of an HA particle via a urea linkage. The left side of the chemical reaction diagram 400 illustrates an isocyanate-functionalized HA particle that may be formed according to process described herein with respect to FIG. 3.

The left side of the chemical reaction diagram 400 further illustrates a second example of a triazine-based herbicide. In FIG. 4A, the triazine-based herbicide includes a secondary amine group and has the following chemical structure:

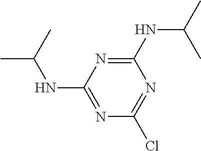

The chemical reaction may include forming a solution that includes the isocyanate-functionalized hydroxyapatite particle and the second example triazine-based herbicide, then initiating a chemical reaction to bind the herbicide to the surface of the HA particle. For example, the isocyanate-functionalized hydroxyapatite particle and a molar excess of the triazine-based herbicide molecule depicted in FIG. 4A may be dissolved or suspended in DMF at an approximate concentration of 1M with respect to the herbicide. The reaction mixture may be stirred vigorously overnight at room temperature or at a temperature up to 100° C. The particles may be collected by filtration or by precipitation into a non-solvent such as methanol, acetone, diethyl ether, or hexane. The particles may be rinsed with additional solvent, purified by centrifugation, and dried in a vacuum oven. The right side of the chemical reaction diagram 400 illustrates that one of the secondary amine groups of the triazine-based herbicide reacts with the isocyanate groups to form urea linkages.

Referring to FIG. 4B, a chemical reaction diagram 410 illustrates that the urea bonds are hydrolysable groups that revert the original amine structure back to its starting form, leaving an amine-functionalized HA particle. FIG. 4B illustrates that the hydrolysis reaction leaves the original triazine herbicide free to act upon undesirable plants and weeds. In FIG. 4B, the dashed arrows are designed to depict the intermediate reaction products. Specifically, proceeding from top to bottom, FIG. 4B illustrates that reacting the HA particle (top left) with water results in the bottom-left products (i.e., HAP with amine functionality and the triazine-based herbicide). Proceeding along the dashed reaction arrow from top left to right, FIG. 4B illustrates cleavage of the urea linkage to form the HAP with isocyanate functionality and release of the triazine-based herbicide. Proceeding along the dashed reaction arrow from top right to bottom left, FIG. 4B illustrates that subsequent reaction of the HAP-isocyanate with water evolves carbon dioxide.

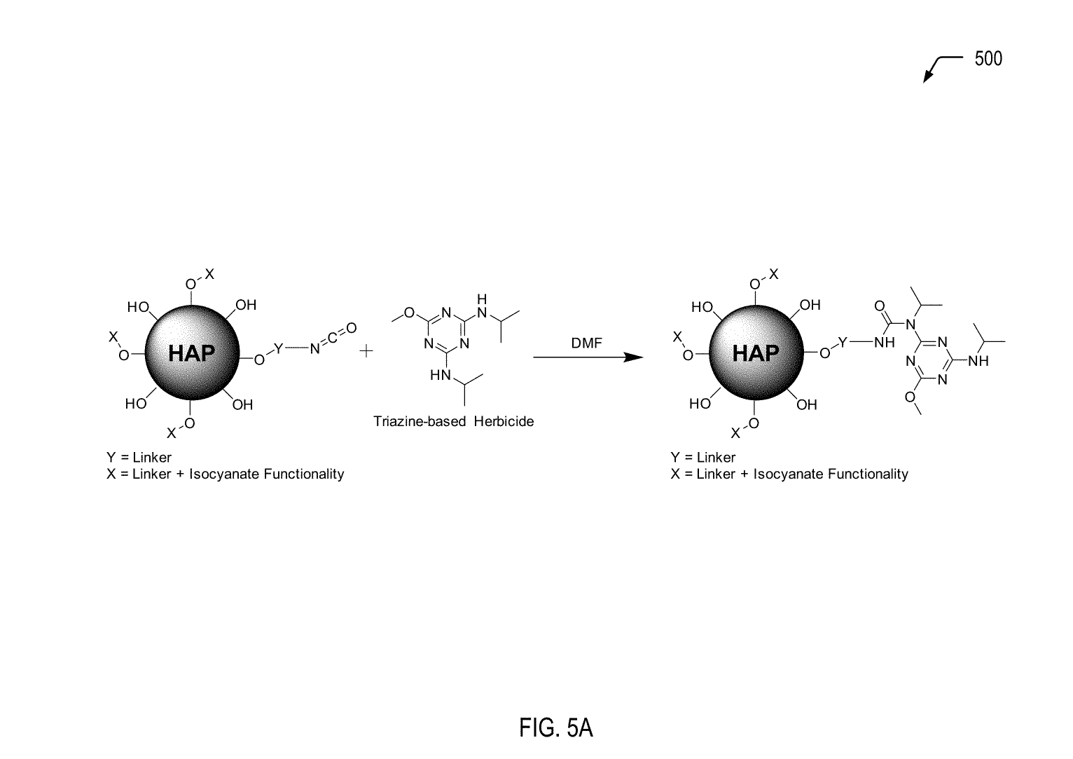

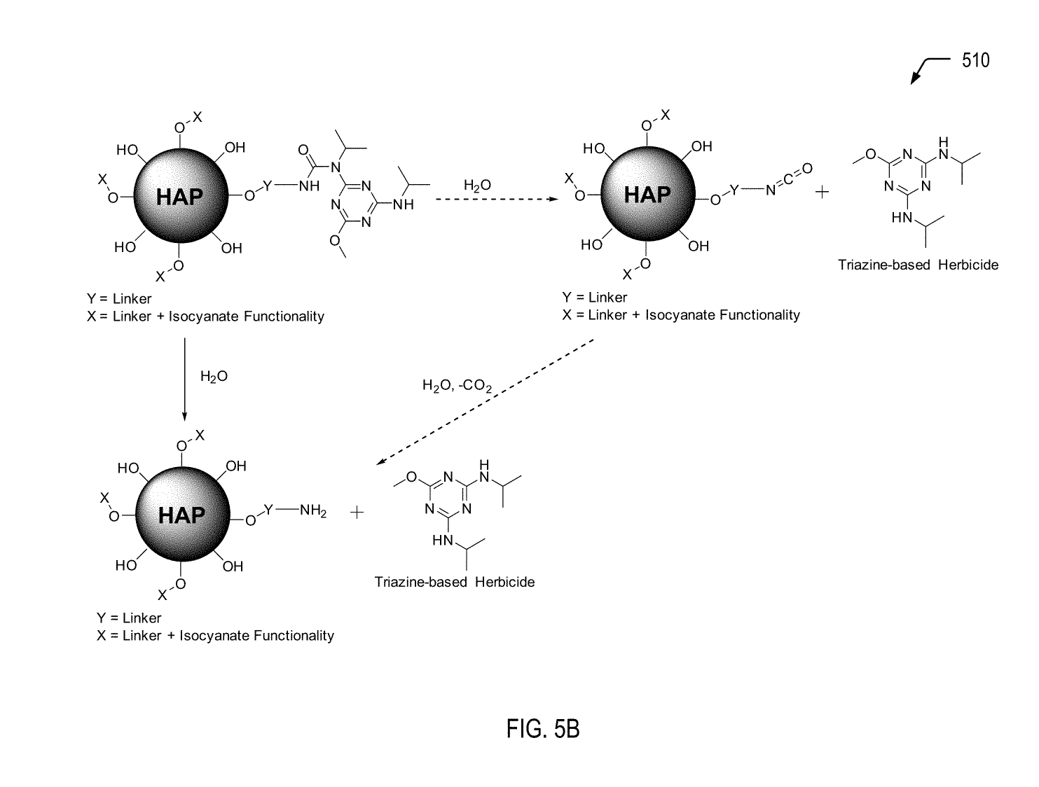

FIGS. 5A and 5B illustrate a process of chemically binding a third example of a triazine-based herbicide to a surface of an isocyanate-functionalized HA particle via a hydrolysable urea linkage to enable controlled release of the triazine-based herbicide, according to one embodiment.

Referring to FIG. 5A, a chemical reaction diagram 500 illustrates an example of a process of chemically binding a triazine-based herbicide to a surface of an HA particle via a urea linkage.

The left side of the chemical reaction diagram 500 illustrates an isocyanate-functionalized HA particle that may be formed according to process described herein with respect to FIG. 3.

The left side of the chemical reaction diagram 500 further illustrates an example of a triazine-based herbicide that includes a secondary amine group having the following chemical structure:

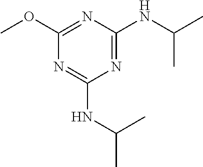 [SMILES: COc1nc(NC(C)C)nc(NC(C)C)n1]

The process may include forming a solution that includes the isocyanate-functionalized hydroxyapatite particle and the third example triazine-based herbicide, then initiating a chemical reaction to bind the herbicide to the surface of the HA particle. For example, the isocyanate-functionalized hydroxyapatite particle and a molar excess of the triazine-based herbicide molecule depicted in FIG. 5A may be dissolved or suspended in DMF at an approximate concentration of 1M with respect to the herbicide. The reaction mixture may be stirred vigorously overnight at room temperature or at a temperature up to 100° C. The particles may be collected by filtration or by precipitation into a non-solvent such as methanol, acetone, diethyl ether, or hexane. The particles may be rinsed with additional solvent, purified by centrifugation, and dried in a vacuum oven. The right side of the chemical reaction diagram 500 illustrates that one of the secondary amine groups of the triazine-based herbicide reacts with the isocyanate groups to form urea linkages.

Referring to FIG. 5B, a chemical reaction diagram 510 illustrates that the urea bonds are hydrolysable groups that revert the original amine structure back to its starting form, leaving an amine-functionalized HA particle. FIG. 5B illustrates that the hydrolysis reaction leaves the original triazine herbicide free to act upon undesirable plants and weeds. In FIG. 5B, the dashed arrows are designed to depict the intermediate reaction products. Specifically, proceeding from top to bottom, FIG. 5B illustrates that reacting the HA particle (top left) with water results in the bottom-left products (i.e., HAP with amine functionality and the triazine-based herbicide). Proceeding along the dashed reaction arrow from top left to right, FIG. 5B illustrates cleavage of the urea linkage to form the HAP with isocyanate functionality and release of the triazine-based herbicide. Proceeding along the dashed reaction arrow from top right to bottom left, FIG. 5B illustrates that subsequent reaction of the HAP-isocyanate with water evolves carbon dioxide.

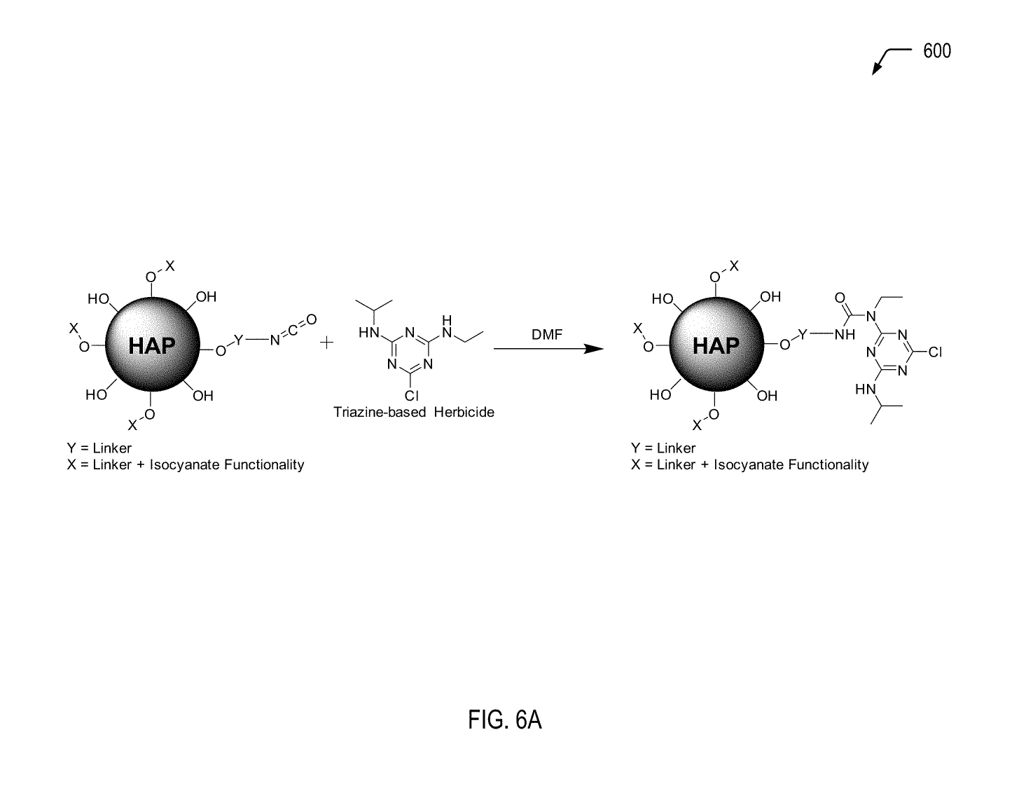

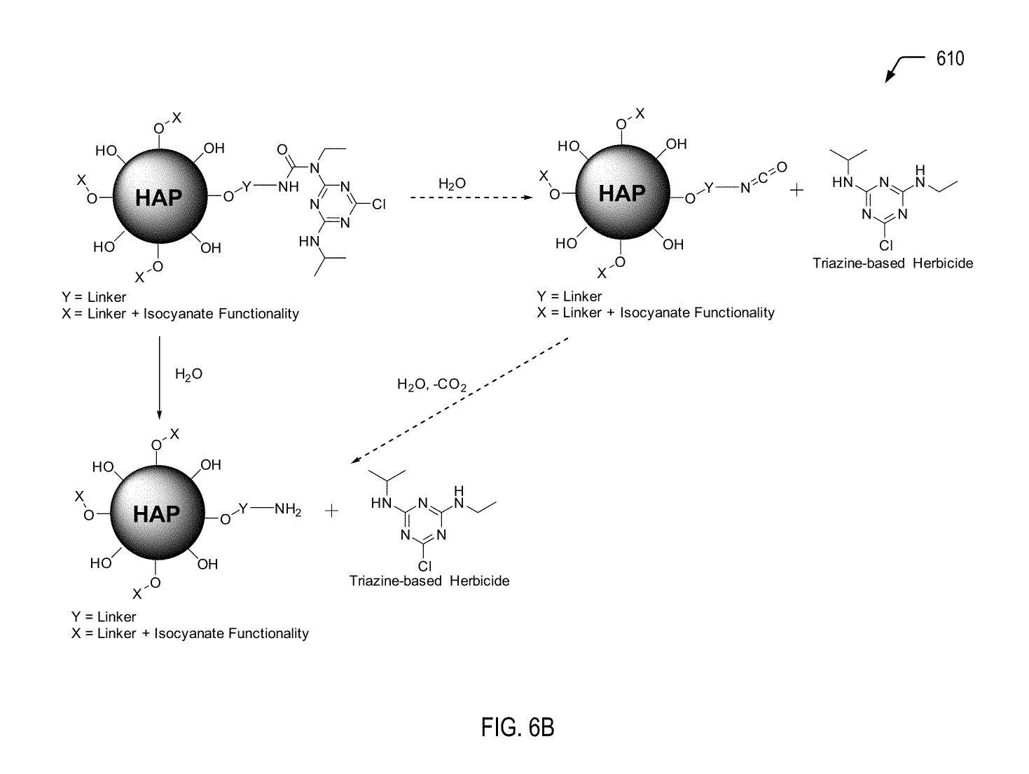

FIGS. 6A and 6 B illustrate a process of chemically binding a fourth example of a triazine-based herbicide to a surface of an isocyanate-functionalized HA particle via a hydrolysable urea linkage to enable controlled release of the triazine-based herbicide, according to one embodiment.

Referring to FIG. 6A, a chemical reaction diagram 600 illustrates an example of a process of chemically binding a triazine-based herbicide to a surface of an HA particle via a urea linkage. The left side of the chemical reaction diagram 600 illustrates an isocyanate-functionalized HA particle that may be formed according to process described herein with respect to FIG. 3.

The left side of the chemical reaction diagram 600 further illustrates an example of a triazine-based herbicide that includes a secondary amine group having the following chemical structure:

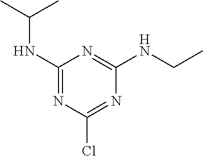

The process may include forming a solution that includes the isocyanate-functionalized hydroxyapatite particle and the fourth example triazine-based herbicide, then initiating a chemical reaction to bind the herbicide to the surface of the HA particle. For example, the isocyanate-functionalized hydroxyapatite particle and a molar excess of the triazine-based herbicide molecule depicted in FIG. 6A may be dissolved or suspended in dimethylformamide (DMF) at an approximate concentration of 1M with respect to the herbicide. The reaction mixture may be stirred vigorously overnight at room temperature or at a temperature up to 100° C. The particles may be collected by filtration or by precipitation into a non-solvent such as methanol, acetone, diethyl ether, or hexane. The particles may be rinsed with additional solvent, purified by centrifugation, and dried in a vacuum oven. The right side of the chemical reaction diagram 600 illustrates that one of the secondary amine groups of the triazine-based herbicide reacts with the isocyanate groups to form urea linkages.

Referring to FIG. 6B, a chemical reaction diagram 610 illustrates that the urea bonds are hydrolysable groups that revert the original amine structure back to its starting form, leaving an amine-functionalized HA particle. FIG. 6B illustrates that the hydrolysis reaction leaves the original triazine herbicide free to act upon undesirable plants and weeds. In FIG. 6B, the dashed arrows are designed to depict the intermediate reaction products. Specifically, proceeding from top to bottom, FIG. 6B illustrates that reacting the HA particle (top left) with water results in the bottom-left products (i.e., HAP with amine functionality and the triazine-based herbicide). Proceeding along the dashed reaction arrow from top left to right, FIG. 6B illustrates cleavage of the urea linkage to form the HAP with isocyanate functionality and release of the triazine-based herbicide. Proceeding along the dashed reaction arrow from top right to bottom left, FIG. 6B illustrates that subsequent reaction of the HAP-isocyanate with water evolves carbon dioxide.

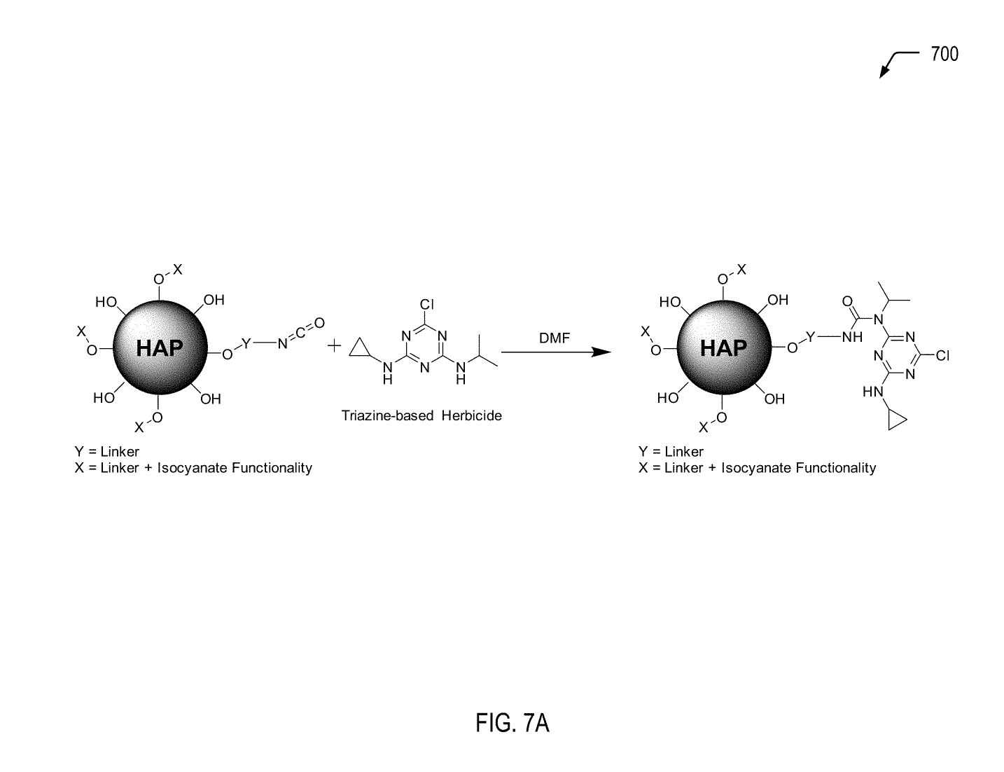

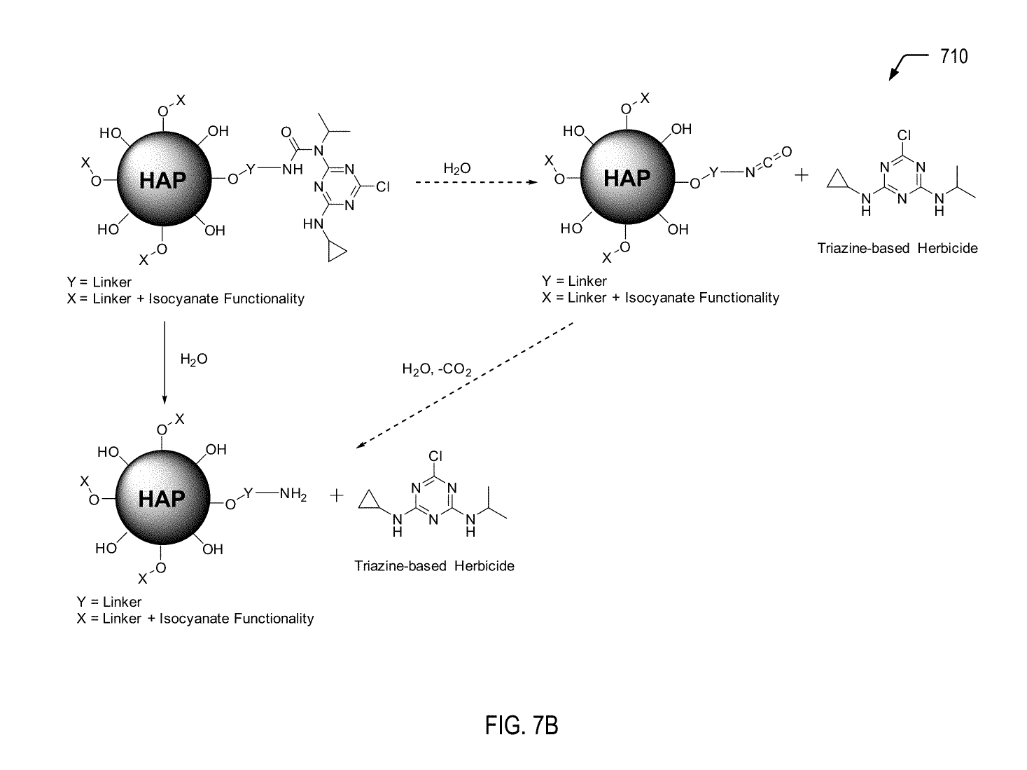

FIGS. 7A and 7B illustrate a process of chemically binding a fifth example of a triazine-based herbicide to a surface of an isocyanate-functionalized HA particle via a hydrolysable urea linkage to enable controlled release of the triazine-based herbicide, according to one embodiment.

Referring to FIG. 7A, a chemical reaction diagram 700 illustrates an example of a process of chemically binding a triazine-based herbicide to a surface of an HA particle via a urea linkage. The left side of the chemical reaction diagram 700 illustrates an isocyanate-functionalized HA particle that may be formed according to process described herein with respect to FIG. 3.

The left side of the chemical reaction diagram 700 further illustrates an example of a triazine-based herbicide that includes a secondary amine group having the following chemical structure:

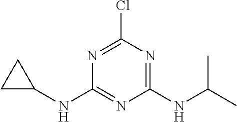

The process may include forming a solution that includes the isocyanate-functionalized hydroxyapatite particle and the fifth example triazine-based herbicide, then initiating a chemical reaction to bind the herbicide to the surface of the HA particle. For example, the isocyanate-functionalized hydroxyapatite particle and a molar excess of the triazine-based herbicide molecule depicted in FIG. 7A may be dissolved or suspended in dimethylformamide (DMF) at an approximate concentration of 1M with respect to the herbicide. The reaction mixture may be stirred vigorously overnight at room temperature or at a temperature up to 100° C. The particles may be collected by filtration or by precipitation into a non-solvent such as methanol, acetone, diethyl ether, or hexane. The particles may be rinsed with additional solvent, purified by centrifugation, and dried in a vacuum oven. The right side of the chemical reaction diagram 700 illustrates that one of the secondary amine groups of the triazine-based herbicide reacts with the isocyanate groups to form urea linkages.

Referring to FIG. 7B, a chemical reaction diagram 710 illustrates that the urea bonds are hydrolysable groups that revert the original amine structure back to its starting form, leaving an amine-functionalized HA particle. FIG. 7B illustrates that the hydrolysis reaction leaves the original triazine herbicide free to act upon undesirable plants and weeds. In FIG. 7B, the dashed arrows are designed to depict the intermediate reaction products. Specifically, proceeding from top to bottom, FIG. 7B illustrates that reacting the HA particle (top left) with water results in the bottom-left products (i.e., HAP with amine functionality and the triazine-based herbicide). Proceeding along the dashed reaction arrow from top left to right, FIG. 7B illustrates cleavage of the urea linkage to form the HAP with isocyanate functionality and release of the triazine-based herbicide. Proceeding along the dashed reaction arrow from top right to bottom left, FIG. 7B illustrates that subsequent reaction of the HAP-isocyanate with water evolves carbon dioxide.

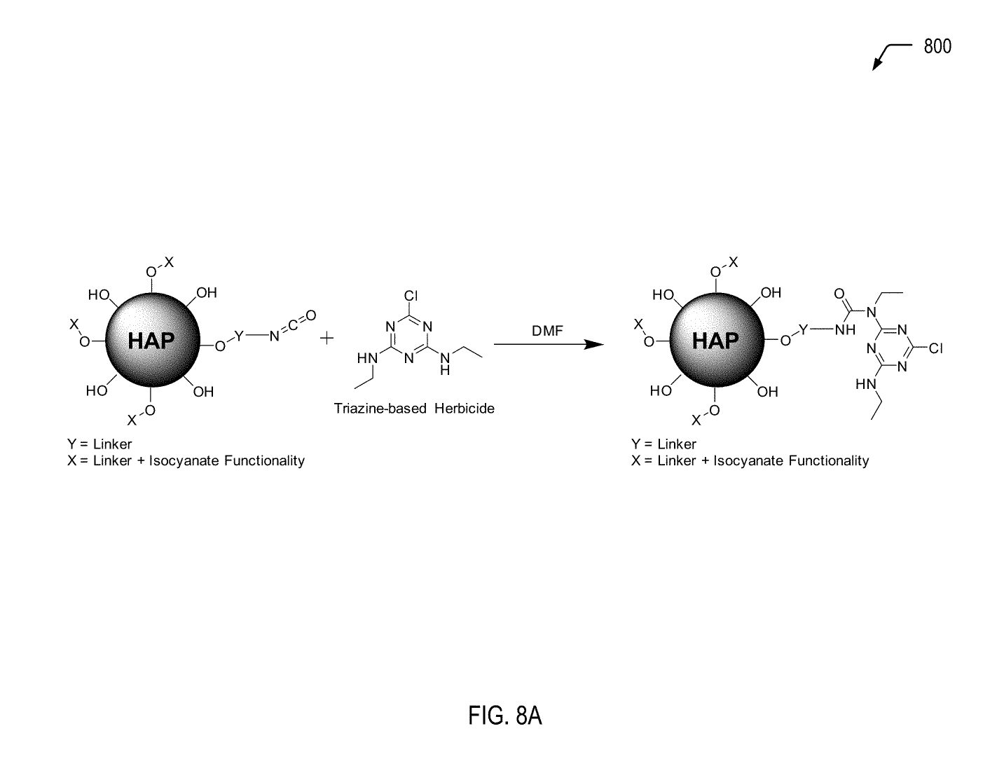

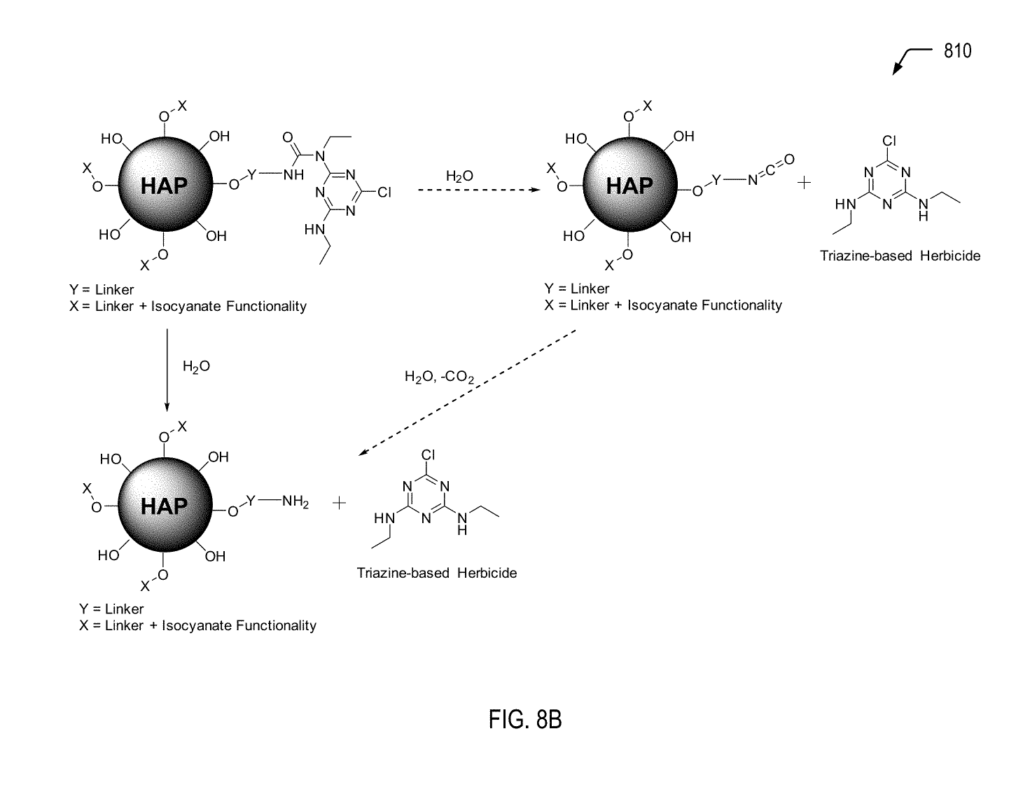

FIGS. 8A and 8B illustrate a process of chemically binding a sixth example of a triazine-based herbicide to a surface of an isocyanate-functionalized HA particle via a hydrolysable urea linkage to enable controlled release of the triazine-based herbicide, according to one embodiment.

Referring to FIG. 8A, a chemical reaction diagram 800 illustrates an example of a process of chemically binding a triazine-based herbicide to a surface of an HA particle via a urea linkage. The left side of the chemical reaction diagram 800 illustrates an isocyanate-functionalized HA particle that may be formed according to process described herein with respect to FIG. 3.

The left side of the chemical reaction diagram 800 further illustrates an example of a triazine-based herbicide that includes a secondary amine group having the following chemical structure:

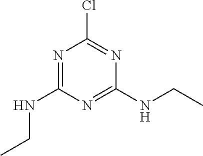

The process may include forming a solution that includes the isocyanate-functionalized hydroxyapatite particle and the sixth example triazine-based herbicide, then initiating a chemical reaction to bind the herbicide to the surface of the HA particle. For example, the isocyanate-functionalized hydroxyapatite particle and a molar excess of the triazine-based herbicide molecule depicted in FIG. 8A may be dissolved or suspended in dimethylformamide (DMF) at an approximate concentration of 1M with respect to the herbicide. The reaction mixture may be stirred vigorously overnight at room temperature or at a temperature up to 100° C. The particles may be collected by filtration or by precipitation into a non-solvent such as methanol, acetone, diethyl ether, or hexane. The particles may be rinsed with additional solvent, purified by centrifugation, and dried in a vacuum oven. The right side of the chemical reaction diagram 800 illustrates that one of the secondary amine groups of the triazine-based herbicide reacts with the isocyanate groups to form urea linkages.

Referring to FIG. 8B, a chemical reaction diagram 810 illustrates that the urea bonds are hydrolysable groups that revert the original amine structure back to its starting form, leaving an amine-functionalized HA particle. FIG. 8B illustrates that the hydrolysis reaction leaves the original triazine herbicide free to act upon undesirable plants and weeds. In FIG. 8B, the dashed arrows are designed to depict the intermediate reaction products. Specifically, proceeding from top to bottom, FIG. 8B illustrates that reacting the HA particle (top left) with water results in the bottom-left products (i.e., HAP with amine functionality and the triazine-based herbicide). Proceeding along the dashed reaction arrow from top left to right, FIG. 8B illustrates cleavage of the urea linkage to form the HAP with isocyanate functionality and release of the triazine-based herbicide. Proceeding along the dashed reaction arrow from top right to bottom left, FIG. 8B illustrates that subsequent reaction of the HAP-isocyanate with water evolves carbon dioxide.

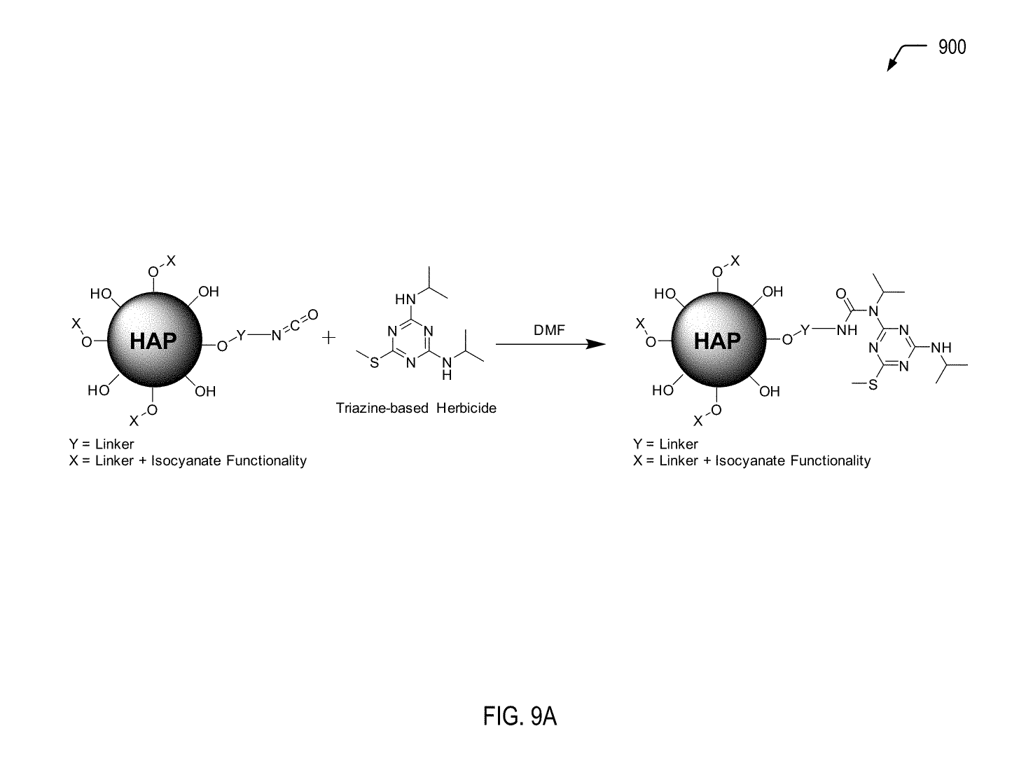

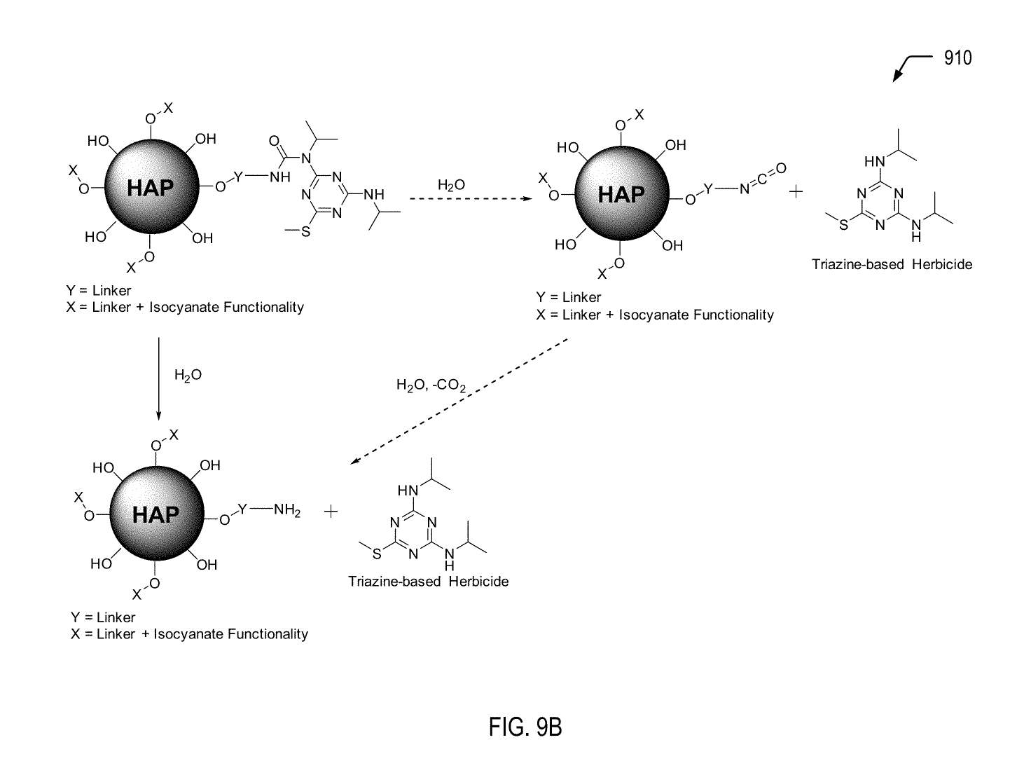

FIGS. 9A and 9B illustrate a process of chemically binding a seventh example of a triazine-based herbicide to a surface of an isocyanate-functionalized HA particle via a hydrolysable urea linkage to enable controlled release of the triazine-based herbicide, according to one embodiment.

Referring to FIG. 9A, a chemical reaction diagram 900 illustrates an example of a process of chemically binding a triazine-based herbicide to a surface of an HA particle via a urea linkage. The left side of the chemical reaction diagram 800 illustrates an isocyanate-functionalized HA particle that may be formed according to process described herein with respect to FIG. 3.

The left side of the chemical reaction diagram 900 further illustrates an example of a triazine-based herbicide that includes a secondary amine group having the following chemical structure:

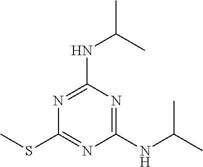 [SMILES: CSc1nc(NC(C)C)nc(NC(C)C)n1]

The process may include forming a solution that includes the isocyanate-functionalized hydroxyapatite particle and the seventh example triazine-based herbicide, then initiating a chemical reaction to bind the herbicide to the surface of the HA particle. For example, the isocyanate-functionalized hydroxyapatite particle and a molar excess of the triazine-based herbicide molecule depicted in FIG. 9A may be dissolved or suspended in dimethylformamide (DMF) at an approximate concentration of 1M with respect to the herbicide. The reaction mixture may be stirred vigorously overnight at room temperature or at a temperature up to 100° C. The particles may be collected by filtration or by precipitation into a non-solvent such as methanol, acetone, diethyl ether, or hexane. The particles may be rinsed with additional solvent, purified by centrifugation, and dried in a vacuum oven. The right side of the chemical reaction diagram 900 illustrates that one of the secondary amine groups of the triazine-based herbicide reacts with the isocyanate groups to form urea linkages.

Referring to FIG. 9B, a chemical reaction diagram 910 illustrates that the urea bonds are hydrolysable groups that revert the original amine structure back to its starting form, leaving an amine-functionalized HA particle. FIG. 9B illustrates that the hydrolysis reaction leaves the original triazine herbicide free to act upon undesirable plants and weeds. In FIG. 9B, the dashed arrows are designed to depict the intermediate reaction products. Specifically, proceeding from top to bottom, FIG. 9B illustrates that reacting the HA particle (top left) with water results in the bottom-left products (i.e., HAP with amine functionality and the triazine-based herbicide). Proceeding along the dashed reaction arrow from top left to right, FIG. 9B illustrates cleavage of the urea linkage to form the HAP with isocyanate functionality and release of the triazine-based herbicide. Proceeding along the dashed reaction arrow from top right to bottom left, FIG. 9B illustrates that subsequent reaction of the HAP-isocyanate with water evolves carbon dioxide.

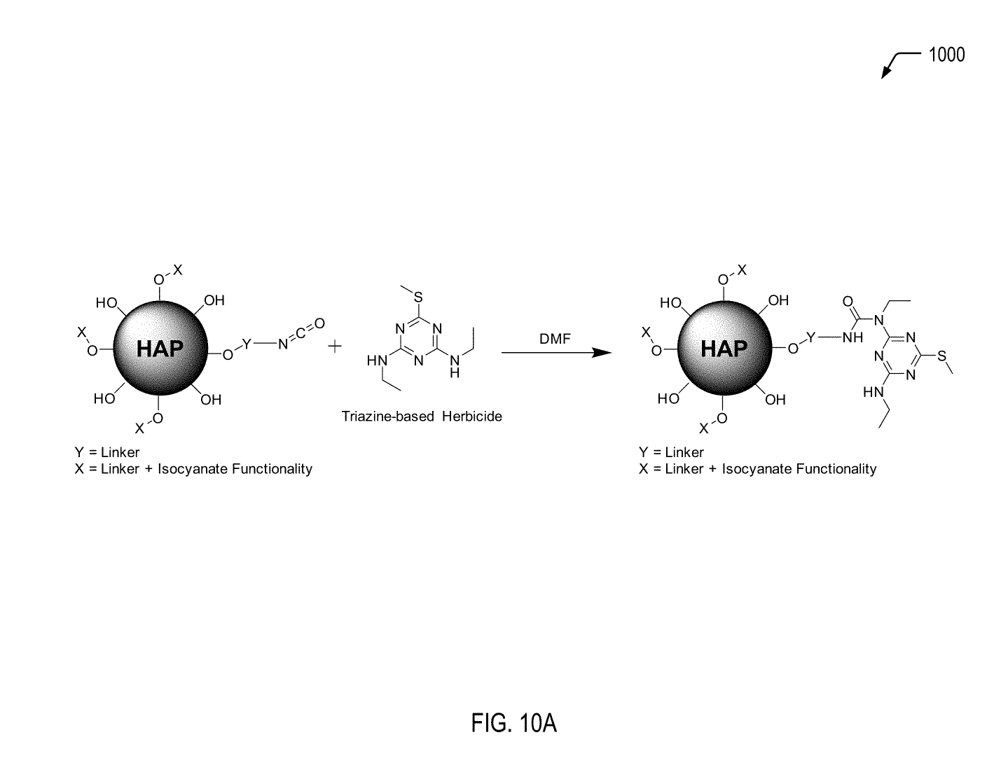

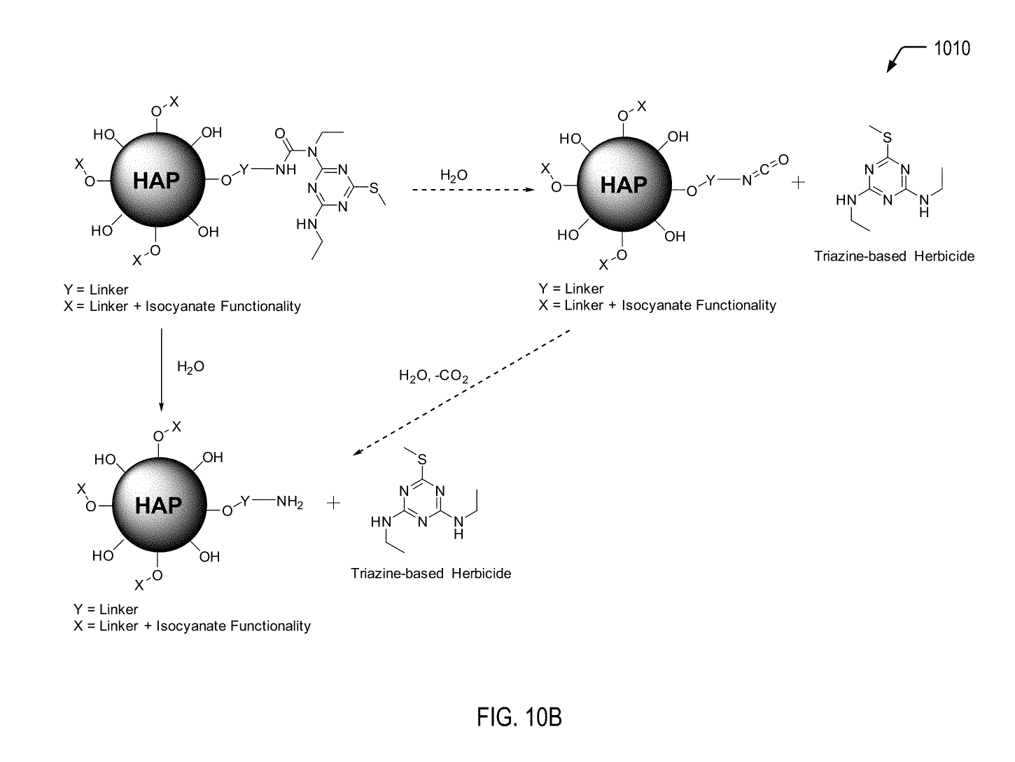

FIGS. 10A and 10B illustrate a process of chemically binding an eighth example of a triazine-based herbicide to a surface of an isocyanate-functionalized HA particle via a hydrolysable urea linkage to enable controlled release of the triazine-based herbicide, according to one embodiment.

Referring to FIG. 10A, a chemical reaction diagram 1000 illustrates an example of a process of chemically binding a triazine-based herbicide to a surface of an HA particle via a urea linkage. The left side of the chemical reaction diagram 1000 illustrates an isocyanate-functionalized HA particle that may be formed according to process described herein with respect to FIG. 3.

The left side of the chemical reaction diagram 1000 further illustrates an example of a triazine-based herbicide that includes a secondary amine group having the following chemical structure:

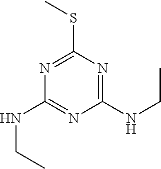

The process may include forming a solution that includes the isocyanate-functionalized hydroxyapatite particle and the eighth example triazine-based herbicide, then initiating a chemical reaction to bind the herbicide to the surface of the HA particle. For example, the isocyanate-functionalized hydroxyapatite particle and a molar excess of the triazine-based herbicide molecule depicted in FIG. 10A may be dissolved or suspended in dimethylformamide (DMF) at an approximate concentration of 1M with respect to the herbicide. The reaction mixture may be stirred vigorously overnight at room temperature or at a temperature up to 100° C. The particles may be collected by filtration or by precipitation into a non-solvent such as methanol, acetone, diethyl ether, or hexane. The particles may be rinsed with additional solvent, purified by centrifugation, and dried in a vacuum oven. The right side of the chemical reaction diagram 1000 illustrates that one of the secondary amine groups of the triazine-based herbicide reacts with the isocyanate groups to form urea linkages.

Referring to FIG. 10B, a chemical reaction diagram 1010 illustrates that the urea bonds are hydrolysable groups that revert the original amine structure back to its starting form, leaving an amine-functionalized HA particle. FIG. 10B illustrates that the hydrolysis reaction leaves the original triazine herbicide free to act upon undesirable plants and weeds. In FIG. 10B, the dashed arrows are designed to depict the intermediate reaction products. Specifically, proceeding from top to bottom, FIG. 10B illustrates that reacting the HA particle (top left) with water results in the bottom-left products (i.e., HAP with amine functionality and the triazine-based herbicide). Proceeding along the dashed reaction arrow from top left to right, FIG. 10B illustrates cleavage of the urea linkage to form the HAP with isocyanate functionality and release of the triazine-based herbicide. Proceeding along the dashed reaction arrow from top right to bottom left, FIG. 10B illustrates that subsequent reaction of the HAP-isocyanate with water evolves carbon dioxide.

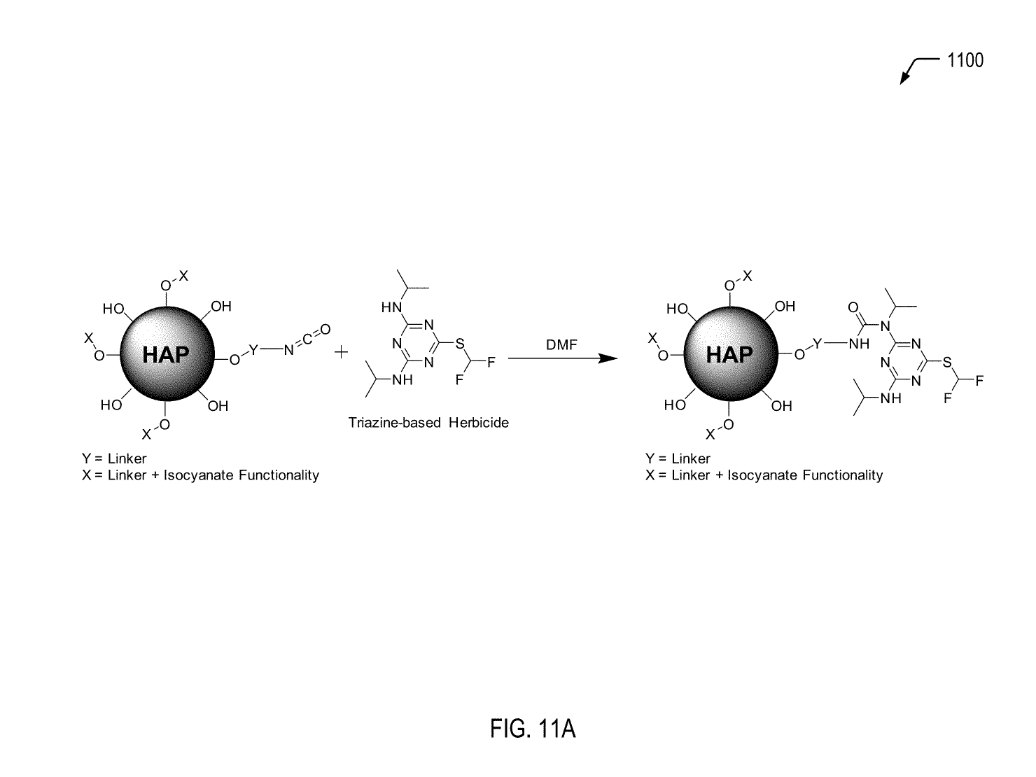

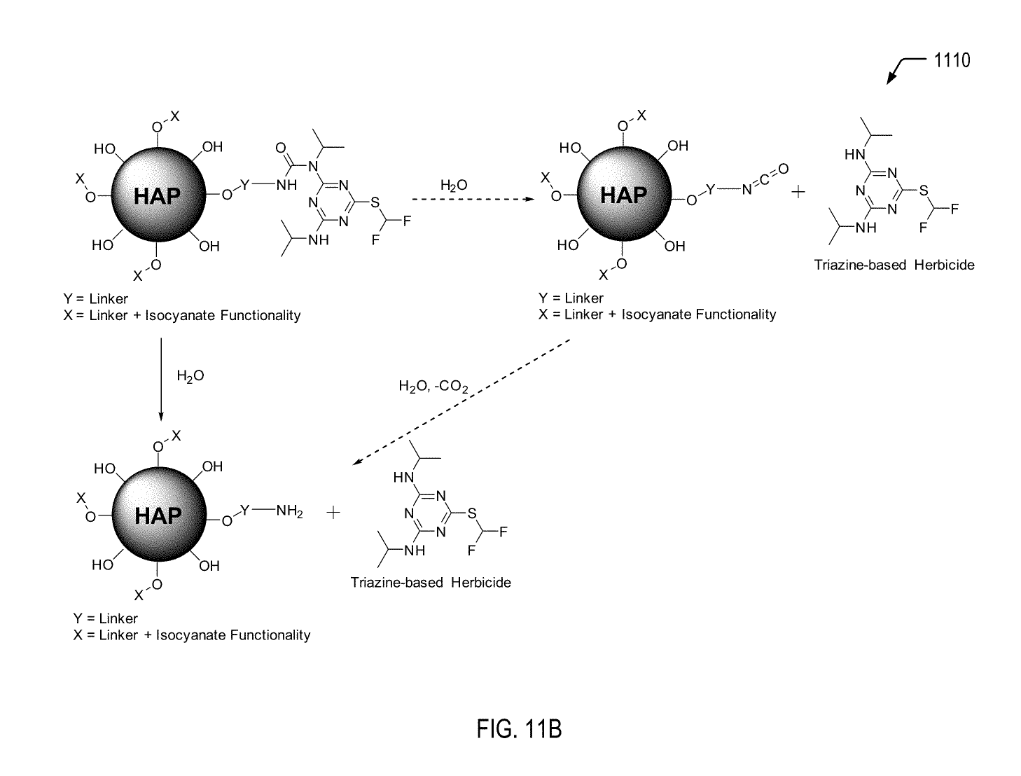

FIGS. 11A and 11B illustrate a process of chemically binding a ninth example of a triazine-based herbicide to a surface of an isocyanate-functionalized HA particle via a hydrolysable urea linkage to enable controlled release of the triazine-based herbicide, according to one embodiment.

Referring to FIG. 11A, a chemical reaction diagram 1100 illustrates an example of a process of chemically binding a triazine-based herbicide to a surface of an HA particle via a urea linkage. The left side of the chemical reaction diagram 1100 illustrates an isocyanate-functionalized HA particle that may be formed according to process described herein with respect to FIG. 3.

The left side of the chemical reaction diagram 1100 further illustrates an example of a triazine-based herbicide that includes a secondary amine group having the following chemical structure:

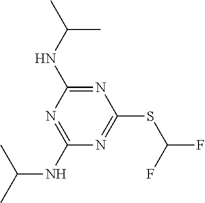 [SMILES: CC(C)Nc1nc(NC(C)C)nc(SC(F)F)n1]

The process may include forming a solution that includes the isocyanate-functionalized hydroxyapatite particle and the ninth example triazine-based herbicide, then initiating a chemical reaction to bind the herbicide to the surface of the HA particle. For example, the isocyanate-functionalized hydroxyapatite particle and a molar excess of the triazine-based herbicide molecule depicted in FIG. 11A may be dissolved or suspended in dimethylformamide (DMF) at an approximate concentration of 1M with respect to the herbicide. The reaction mixture may be stirred vigorously overnight at room temperature or at a temperature up to 100° C. The particles may be collected by filtration or by precipitation into a non-solvent such as methanol, acetone, diethyl ether, or hexane. The particles may be rinsed with additional solvent, purified by centrifugation, and dried in a vacuum oven. The right side of the chemical reaction diagram 1100 illustrates that one of the secondary amine groups of the triazine-based herbicide reacts with the isocyanate groups to form urea linkages.

Referring to FIG. 11B, a chemical reaction diagram 1110 illustrates that the urea bonds are hydrolysable groups that revert the original amine structure back to its starting form, leaving an amine-functionalized HA particle. FIG. 11B illustrates that the hydrolysis reaction leaves the original triazine herbicide free to act upon undesirable plants and weeds. In FIG. 11B, the dashed arrows are designed to depict the intermediate reaction products. Specifically, proceeding from top to bottom, FIG. 11B illustrates that reacting the HA particle (top left) with water results in the bottom-left products (i.e., HAP with amine functionality and the triazine-based herbicide). Proceeding along the dashed reaction arrow from top left to right, FIG. 11B illustrates cleavage of the urea linkage to form the HAP with isocyanate functionality and release of the triazine-based herbicide. Proceeding along the dashed reaction arrow from top right to bottom left, FIG. 11B illustrates that subsequent reaction of the HAP-isocyanate with water evolves carbon dioxide.

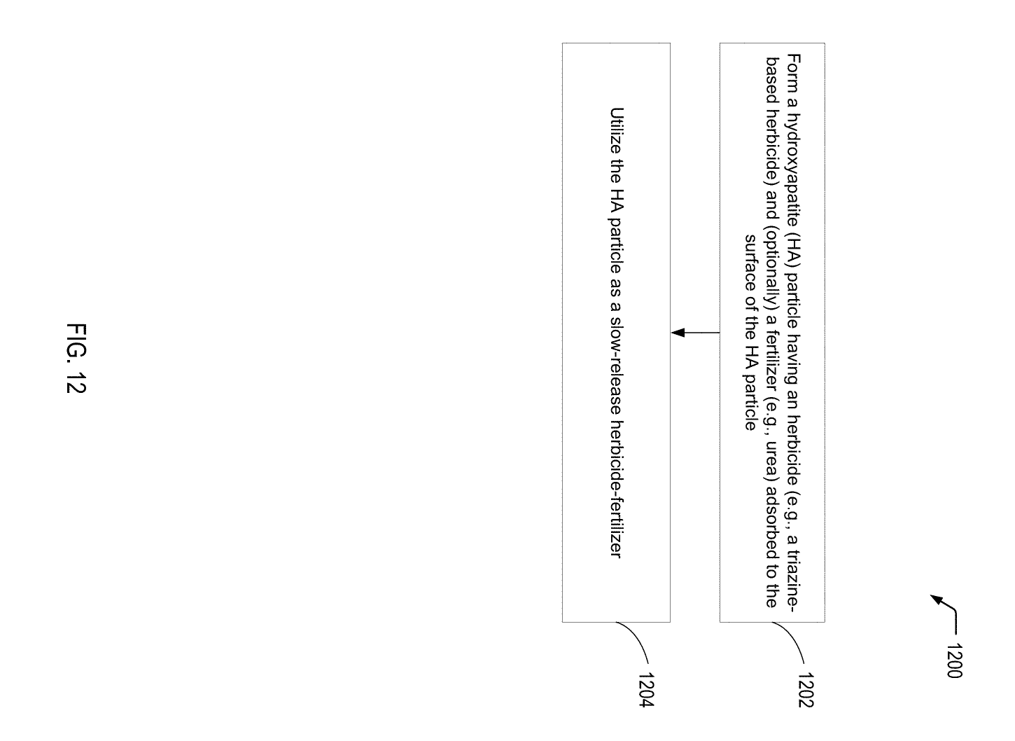

FIG. 12 is a flow diagram an example of a process 1200 of forming a composition of matter that includes a hydroxyapatite particle and a triazine-based herbicide adsorbed to a surface of the hydroxyapatite particle, according to one embodiment. In the particular embodiment depicted in FIG. 12, the composition of matter further includes a fertilizer (urea) adsorbed to the surface of the hydroxyapatite particle.

The process 1200 includes forming an HA particle having an herbicide adsorbed to the surface of the HA particle, at 1202. FIG. 12 illustrates that, in some cases, a fertilizer (urea) may also be adsorbed to the surface of the HA particle. For example, referring to FIG. 1, one of the triazine-based herbicides and (optionally) urea may be adsorbed to the surface of the HA particle.

The process 1200 includes utilizing the HA particle as a slow-release herbicide-fertilizer, at 1204. For example, the HA particle depicted in FIG. 1 may be utilized as a slow-release herbicide-fertilizer. Adsorption of the herbicide to the HA particle enables controlled release of the triazine-based herbicide to act upon undesirable plants and weeds. Adsorption of urea to the HA particle enables controlled release of fertilizer to address the challenges associated with the premature decomposition of urea in soil.

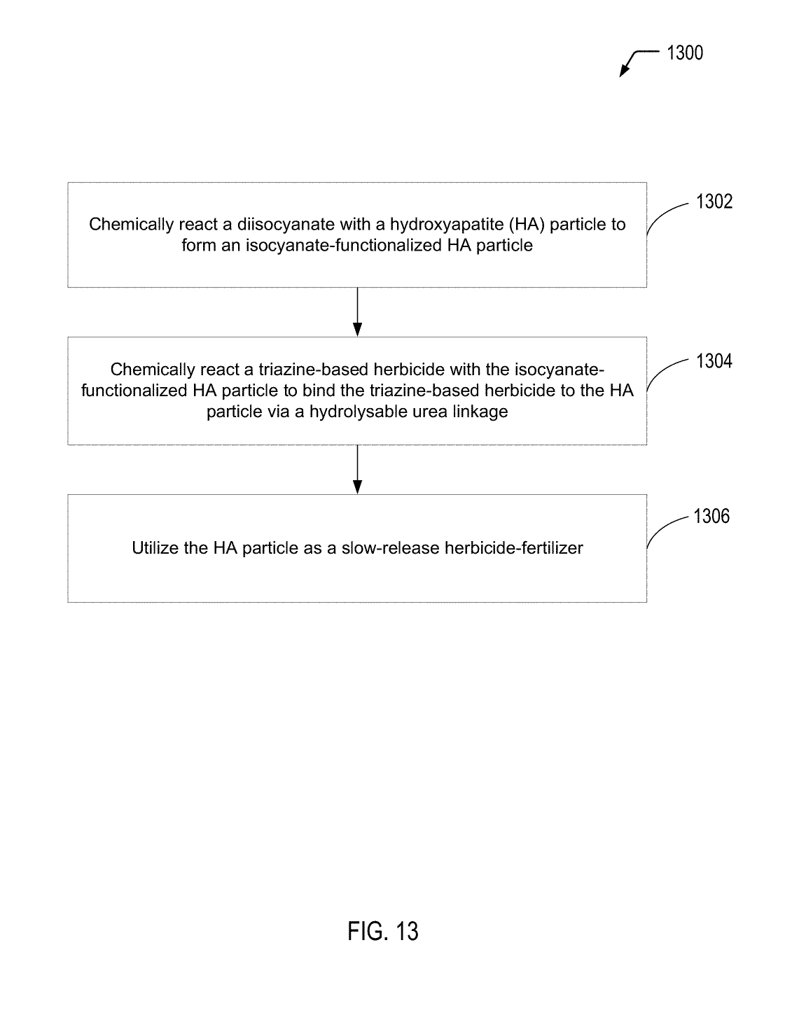

FIG. 13 is a flow diagram illustrating an example of a process 1300 of forming a composition of matter that includes a hydroxyapatite particle and a triazine-based herbicide chemically bound to a surface of the hydroxyapatite particle via a urea linkage according to one embodiment.

The process 1300 includes forming an isocyanate-functionalized HA particle, at 1302. For example, referring to FIG. 3, a diisocyanate material (e.g., MDI or TDI) may be chemically reacted with surface hydroxyl groups of an HA particle to form the isocyanate-functionalized HA particle.

The process 1300 includes chemically reacting a triazine-based herbicide with the isocyanate-functionalized HA particle, at 1304. For example, as previously described herein with respect to FIGS. 2A-2B and 4A-11B, the isocyanate group may chemically react with an amine group of a triazine-based herbicide to chemically bind the triazine-based herbicide to the surface of the HA particle via a urea linkage.

In the particular embodiment depicted in FIG. 13, the process 1300 includes utilizing the HA particle as a slow-release herbicide-fertilizer, at 1306. For example, the HA particle depicted in FIGS. 2A-2B and 4A-11B may be utilized as a slow-release herbicide-fertilizer. Chemically binding of the herbicide to the HA particle enables controlled release of the triazine-based herbicide to act upon undesirable plants and weeds.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A composition of matter comprising:
a hydroxyapatite particle; and
a triazine-based herbicide adsorbed to a surface of the hydroxyapatite particle.

2. The composition of matter of claim 1, further comprising a urea molecule adsorbed to the surface of the hydroxyapatite particle.

3. The composition of matter of claim 1, wherein the triazine-based herbicide is a preemergent herbicide.

4. A composition of matter comprising:
a hydroxyapatite particle; and
a triazine-based herbicide chemically bound to a surface of the hydroxyapatite particle via a urea linkage.

5. The composition of matter of claim 4, wherein the triazine-based herbicide is a preemergent herbicide.

6. The composition of matter of claim 4, wherein the urea linkage is formed via a chemical reaction of an amine group of the triazine-based herbicide and an isocyanate functional group that is linked to the surface of the hydroxyapatite particle.

7. A process comprising:
forming a solution that includes an isocyanate-functionalized hydroxyapatite particle and a triazine-based herbicide, the isocyanate-functionalized hydroxyapatite particle including an isocyanate functional group that is linked to a surface of the hydroxyapatite particle; and
initiating a chemical reaction to chemically bind the triazine-based herbicide to the surface of the hydroxyapatite particle via a urea linkage, the urea linkage resulting from a chemical reaction of an amine group of the triazine-based herbicide and the isocyanate functional group of the isocyanate-functionalized hydroxyapatite particle.

8. The process of claim 7, further comprising chemically reacting a diisocyanate material with surface hydroxyl groups of a hydroxyapatite particle to form the isocyanate-functionalized hydroxyapatite particle.

9. The process of claim 8, wherein the diisocyanate material includes methylene diphenyl diisocyanate (MDI) or toluene diisocyanate (TDI).

10. The process of claim 7, wherein the triazine-based herbicide includes a primary amine group.

11. The process of claim 7, wherein the triazine-based herbicide includes a secondary amine group.

12. The process of claim 7, wherein the triazine-based herbicide has the following chemical structure:

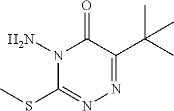

13. The process of claim 7, wherein the triazine-based herbicide has the following chemical structure:

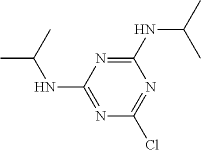

14. The process of claim 7, wherein the triazine-based herbicide has the following chemical structure:

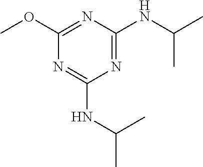 [SMILES: COc1nc(NC(C)C)nc(NC(C)C)n1]

15. The process of claim 7, wherein the triazine-based herbicide has the following chemical structure:

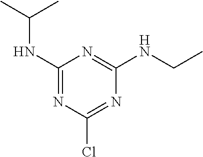

16. The process of claim 7, wherein the triazine-based herbicide has the following chemical structure:

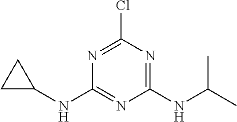

17. The process of claim 7, wherein the triazine-based herbicide has the following chemical structure:

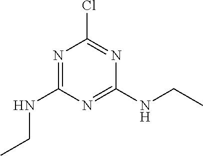

18. The process of claim 7, wherein the triazine-based herbicide has the following chemical structure:

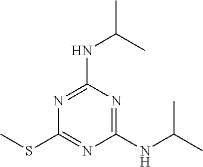 [SMILES: CSc1nc(NC(C)C)nc(NC(C)C)n1]

19. The process of claim 7, wherein the triazine-based herbicide has the following chemical structure:

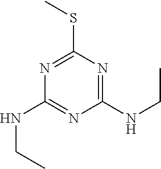

20. The process of claim 7, wherein the triazine-based herbicide has the following chemical structure: 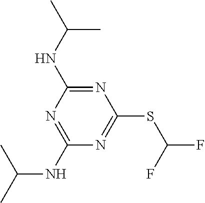 [SMILES: CC(C)Nc1nc(NC(C)C)nc(SC(F)F)n1]
